(19) United States
(12) Patent Application Publication
(10) Pub. No.: US 2012/0188963 A1
(43) Pub. Date: Jul. 26, 2012

(54) MOBILE COMMUNICATION METHOD, MOBILE STATION, AND RADIO BASE STATION

(75) Inventors: Mikio Iwamura, Minato-ku (JP); Sadayuki Abeta, Yokohama-shi (JP)

(73) Assignee: NTT DOCOMO, INC., Tokyo (JP)

(21) Appl. No.: 13/390,977

(22) PCT Filed: Aug. 13, 2010
(86) PCT No.: PCT/JP2010/063767

§ 371 Date: Apr. 11, 2012

(30) Foreign Application Priority Data
Aug. 17, 2009 (JP) 2009-188793

(51) Int. Cl. H04W 72/12

(52) U.S. Cl. 370/329

(57) ABSTRACT

A mobile communication system according to the present invention includes: a step in which a mobile station UE, upon reception of a first uplink scheduling grant containing C-RNTI of the mobile station UE, transmits, by using an individual uplink resource designated by the uplink scheduling grant, an uplink data signal on which a scrambling process has been performed by the C-RNTI of the mobile station UE, to a radio base station eNB; and a step in which the mobile station UE, upon reception of a second uplink scheduling grant containing CB-RNTI, transmits, by using a shared uplink resource designated by the second uplink scheduling grant, an uplink data signal on which a scrambling process has been performed by the CB-RNTI, to the radio base station eNB.

### TECHNICAL FIELD

The present invention relates to a mobile communication method, a mobile station, and a radio base station.

### BACKGROUND ART

The Standards Determination Committee for LTE (Long Term Evolution)-Advanced schemes has proposed adaptation of a contention-based uplink transmission control method using “Contention Based Grant”. A contention-based uplink transmission control method using the “Contention Based Grant” will be simply described below.

Firstly, in addition to an uplink scheduling grant transmitted through PDCCH (Physical Downlink Control Channel) addressed to C-RNTI (Cell-Radio Network Temporary Identity) of a mobile station UE, the mobile station UE can monitor and receive an uplink scheduling grant transmitted though the PDCCH addressed to CB-RNTI (Contention Based-Radio Network Temporary Identity).

Secondly, when the mobile station UE has received an uplink scheduling grant transmitted though PDCCH addressed to CB-RNTI, an uplink data signal is transmitted through PUSCH (Physical Uplink Shared Channel) using TF (Transmission Format), MCS (Modulation and Code Scheme), RB (Resource Blocks) or the like that are designated by the uplink scheduling grant.

The mobile station UE adds “MAC CE (Control Element)” including the C-RNTI of the mobile station UE to the uplink data signal to enable identification of by whom the uplink data signal has been transmitted.

As a result, application of the contention-based uplink transmission control method using the “Contention Based Grant” is expected to be capable of a reduction in transmission delay of the uplink data signal by enabling omission of the L2 procedure of “transmission of scheduling request by mobile station UE”→“transmission of uplink scheduling grant by radio base station eNB”,→“transmission of buffer status report by mobile station UE”,→“transmission of uplink scheduling grant by radio base station eNB”,→“transmission of uplink data signal by mobile station UE”.

Application of contention-based uplink transmission control method using “Contention Based Grant” is expected to be capable of effective application to uplink resources that are not used after normal scheduling addressed to the C-RNTI.

### SUMMARY OF THE INVENTION

### Problems to be Solved by the Invention

However, there is a problem that, since the mobile station UE is configured to transmit the uplink data signal on which a scrambling process has been performed using C-RNTI of the mobile station UE in a conventional mobile communication system of LTE-Re1.8 scheme, the radio base station eNB cannot predict which mobile station UE will transmit an uplink data signal by using a shared resource designated by the uplink scheduling grant transmitted through PDCCH addressed to CB-RNTI, and cannot properly apply a descrambling process to the uplink data signal transmitted through the shared resource.

The present invention has been achieved in view of the above-described problems, and an object thereof is to provide a mobile communication method in which a radio base station eNB can appropriately apply a descrambling process to the uplink data signal transmitted through the shared resource when the contention-based uplink transmission control method using “Contention Based Grant” is used, and also to provide a mobile station therefor and a radio base station therefor.

### Means for Solving the Problem

A first characteristic of the present invention is summarized as a mobile communication method, comprising, a step in which a mobile station, upon reception of a first uplink scheduling signal containing identification information of the mobile station from a radio base station, transmits, by using an individual uplink resource designated by the first uplink scheduling signal, an uplink data signal on which a scrambling process has been performed using the identification information of the mobile station, to the radio base station, and a step in which the mobile station, upon reception of a second uplink scheduling signal containing predetermined identification information that is not identification information of a specific mobile station from the radio base station, transmits, by using a shared uplink resource designated by the second uplink scheduling signal, an uplink data signal on which a scrambling process has been performed using the predetermined identification information, to the radio base station.

A second characteristic of the present invention is summarized as a mobile station, comprising, a first transmission unit configured to transmit, upon reception of a first uplink scheduling signal containing identification information of the mobile station from a radio base station, by using an individual uplink resource designated by the first uplink scheduling signal, an uplink data signal on which a scrambling process has been performed using the identification information of the mobile station, to the radio base station, and a second transmission unit configured to transmit, upon reception of a second uplink scheduling signal containing predetermined identification information that is not identification information of a specific mobile station from the radio base station, by using a shared uplink resource designated by the second uplink scheduling signal, an uplink data signal on which a scrambling process has been performed using the predetermined identification information, to the radio base station.

A third characteristic of the present invention is summarized as a radio base station, comprising, a transmission unit configured to transmit a first uplink scheduling signal that contains identification information of a mobile station and designates an individual uplink resource and to transmit a second uplink scheduling signal that contains predetermined identification information that is not identification information of a specific mobile station and designates a shared uplink resource, and a descrambling processing unit configured to apply a descrambling process using the identification information of the mobile station, on an uplink data signal transmitted using the individual uplink resource by a mobile station and to apply a descrambling process using the predetermined identification information, on an uplink data signal transmitted using the shared uplink resource by the mobile station.

### Effect of the Invention

As described above, according to the present invention, it is possible to provide a mobile communication method in which a radio base station eNB can appropriately apply a descrambling process to the uplink data signal transmitted through the shared resource when the contention-based uplink transmission control method using “Contention Based Grant” is used, and also to provide a mobile station therefor and a radio base station therefor.

### BRIEF DESCRIPTION OF THE DRAWINGS

FIG. 1 is a diagram showing the entire configuration of a mobile communication system according to a first embodiment of the present invention.

FIG. 2 is a functional block diagram of the mobile station according to the first embodiment of the present invention.

FIG. 3 is a functional block diagram of a radio base station according to the first embodiment of the present invention.

FIG. 4 is a sequence diagram showing an operation of the mobile communication system according to the first embodiment of the present invention.

### BEST MODES FOR CARRYING OUT THE INVENTION

(Configuration of Mobile Communication System According to First Embodiment of the Present Invention)

With reference to FIG. 1 to FIG. 3, the configuration of a mobile communication system according to a first embodiment of the present invention will be described.

The mobile communication system according to the present embodiment is an LTE-Advanced mobile communication system that is configured to apply a contention-based uplink transmission control method using “Contention Based Grant” in relation to a mobile station UE that maintains an uplink synchronous state.

As illustrated in FIG. 1, the mobile communication system according to the present embodiment is configured so that a mobile station UE transmits an uplink data signal through PUSCH to a radio base station eNB, and transmits an uplink control signal through PUCCH (Physical Uplink Control Channel).

Meanwhile, in the mobile communication system according to the present embodiment, the radio base station eNB is configured to transmit a downlink data signal to the mobile station UE through PDSCH (Physical Downlink Shared Channel) and transmit a downlink control signal to the mobile station UE through PDCCH.

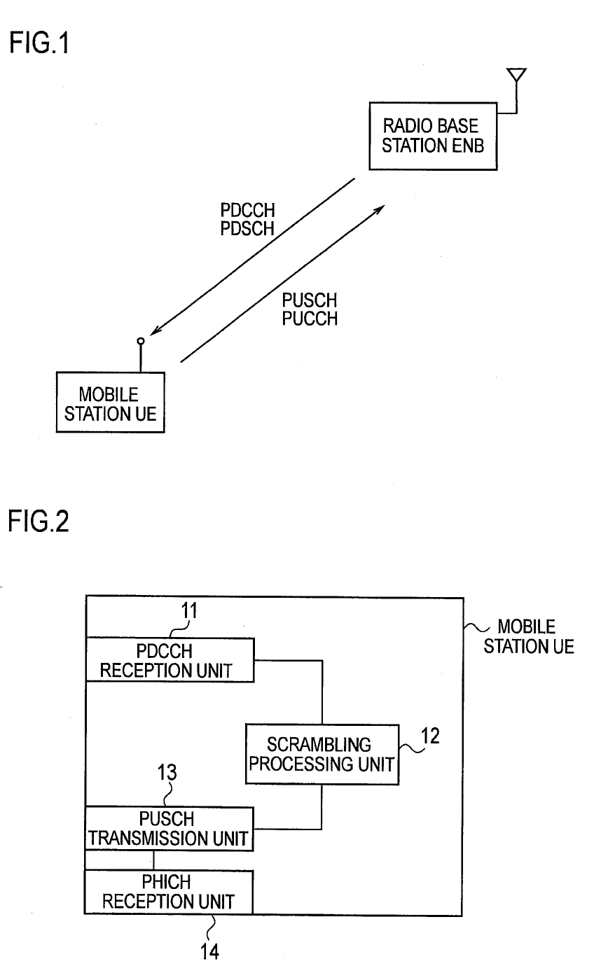

As illustrated in FIG. 2, the mobile station UE is equipped with a PDCCH reception unit 11, a scrambling processing unit 12, a PUSCH transmission unit 13, and a PHICH reception unit 14.

The PDCCH reception unit 11 is configured to receive an uplink scheduling grant that is transmitted through the PDCCH addressed to the C-RNTI of the mobile station UE, in other words, it is configured to receive a first uplink scheduling grant (first uplink scheduling signal) including C-RNTI of the mobile station UE through PDCCH.

Furthermore, the PDCCH reception unit 11 is configured to receive an uplink scheduling grant that is transmitted through the PDCCH addressed to CB-RNTI, in other words, it is configured to receive a second uplink scheduling grant (second uplink scheduling signal) including CB-RNTI.

In addition, the CB-RNTI is predetermined identification information which is not the CR-NTI of a specific mobile station UE. The CB-RNTI may be designated by broadcast information by the radio base station eNB or may be designated by individual signaling (for example, an RRC message) by the radio base station eNB.

A scrambling processing unit 12 is so configured that the C-RNTI of a mobile station UE performs a scrambling process on an uplink data signal transmitted by using an individual uplink resource designated by the first uplink scheduling grant.

Further, the scrambling processing unit 12 is so configured that the CB-RNTI of a mobile station UE performs a scrambling process on an uplink data signal transmitted by using a shared uplink resource designated by a second uplink scheduling grant.

For example, the scrambling process performed by the scrambling processing unit 12 uses CB-RNTI instead of C-RNTI as “nRNTI” in the scrambling process described in chapter 5.3.1 “Scrambling” of specification TS35.211 of 3GPP.

As used herein, since the first uplink scheduling grant designates the available uplink resources of only the mobile station UE, in the present specification, the uplink resources designated by that first uplink scheduling grant are termed “individual uplink resources”.

On the other hand, since the second uplink scheduling grant designates the available uplink resources of a plurality of mobile stations UE, in the present specification, the uplink resources designated by that second uplink scheduling grant are termed “shared uplink resources”.

A PUSCH transmission unit 13 is configured to transmit the uplink data signal on which the scrambling process has been performed by the scrambling processing unit 12 using C-RNTI of the mobile station UE, by using the individual uplink resource designated by the first uplink scheduling grant through PUSCH.

Further, the PUSCH transmission unit 13 is configured to transmit the uplink data signal on which the scrambling process has been performed by the scrambling processing unit 12 using CB-RNTI through the PUSCH, by using the shared uplink resource designated by the second uplink scheduling grant.

The PHICH reception unit 14 is configured to receive a transmission acknowledgement signal (ACK/NACK) indicating a reception result of the uplink data signal transmitted by the PUSCH transmission unit 13 through PHICH (Physical HARQ Indicator Channel).

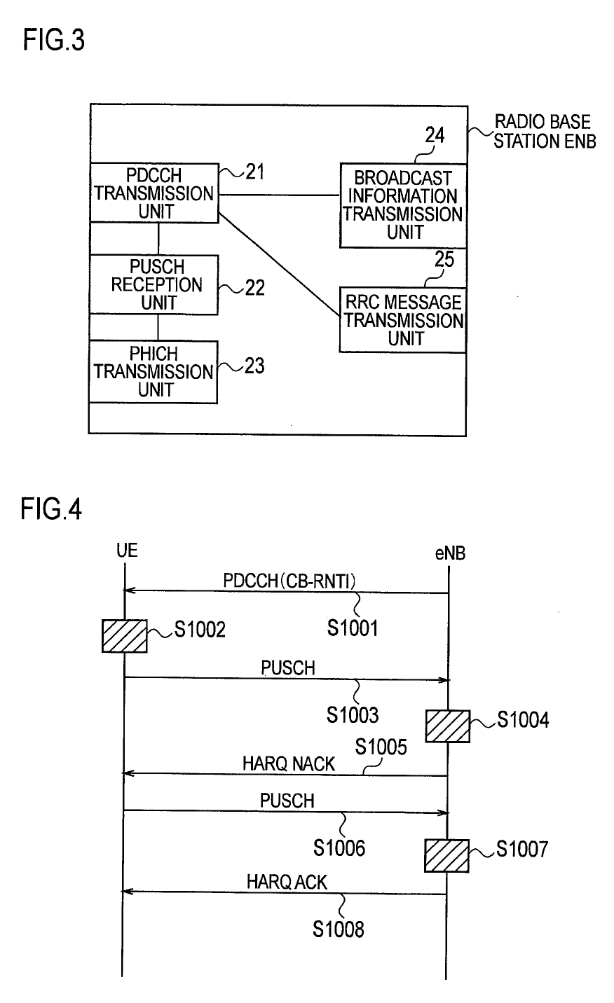

As illustrated in FIG. 3, the radio base station eNB is equipped with a PDCCH transmission unit 21, a PUSCH reception unit 22, a PHICH transmission unit 23, a broadcast information transmission unit 24, and an RRC message transmission unit 25.

The PDCCH transmission unit 21 is configured to transmit an uplink scheduling grant through the PDCCH addressed to C-RNTI of a mobile station UE, in other words, configured to transmit the first uplink scheduling grant that designates an individual uplink resource containing C-RNTI of the mobile station UE through the PDCCH.

Further, the PDCCH transmission unit 21 is configured to transmit the uplink scheduling grant through the PDCCH addressed to CB-RNTI, in other words, configured to transmit the second uplink scheduling grant that designates a shared uplink resource containing CB-RNTI through the PDCCH.

The PUSCH reception unit 22 is configured to receive the uplink data signal transmitted through PUSCH by performing descrambling process, using C-RNTI of a mobile station UE, on the uplink data signal transmitted by the mobile station UE using an individual uplink resource.

Further, the PUSCH reception unit 22 is configured to receive the uplink data signal transmitted through the PUSCH by performing the descrambling process, using CB-RNTI, on the uplink data signal transmitted by the mobile station UE using the shared uplink resource.

The PHICH transmission unit 23 is configured to transmit a transmission acknowledgement signal (ACK/NACK) that indicates the reception result of the uplink data signal from the mobile station UE in the PUSCH reception unit 22, through the PHICH, to the mobile station UE.

A broadcast information transmission unit 24 is configured to transmit broadcast information. Here, the broadcast information transmission unit 24 may be configured to notify the above-described CB-RNTI by the broadcast information.

An RRC message transmission unit 25 is configured to transmit an RRC (Radio Resource Control) message to a mobile station UE. Here, the RRC message transmission unit 25 may be configured to notify the above-described CB-RNTI by the RRC message.

(Operation of the Mobile Communication System According to the First Embodiment of the Present Invention)

With reference to FIG. 4, the operation of the mobile communication system according to the first embodiment of the present invention will be described.

As illustrated in FIG. 4, in step S1001, the radio base station eNB transmits an uplink scheduling grant through the PDCCH addressed to CB-RNTI.

In step S1002, the mobile station UE receives the uplink scheduling grant.

In step S1003, the mobile station UE transmits the uplink data signal on which a scrambling process has been performed by CB-RNTI to the radio base station eNB through PUSCH by using a shared uplink resource designated by the uplink scheduling grant.

In step S1004, the radio base station eNB performs a descrambling process which uses a demodulation process and CB-RNTI on an uplink data signal that has been received.

After that, if a CRC check result is determined to be “NG”, the radio base station eNB transmits HARQ-NACK to the mobile station UE through PHICH in step S1005.

In step S1006, the mobile station UE retransmits the above-described uplink data signal through PUSCH.

In step S1007, the radio base station eNB performs the descrambling process that uses the demodulation process and the CB-RNTI on the uplink data signal that has been received.

After that, the radio base station eNB transmits the HARQ-ACK to the mobile station UE through the PHICH in step S1008 if a CRC check result is determined to be “OK”.

(Operation and Effect of the Mobile Communication System According to the First Embodiment of the Present Invention)

In the mobile communication system according to the first embodiment of the present invention, the radio base station eNB can appropriately perform the descrambling process, using a known CB-RNTI, on the uplink data signal received through the shared resource designated by the uplink scheduling grant containing CB-RNTI.

The characteristics of the present embodiment as described above may be expressed as follows.

A first characteristic of the embodiment is summarized as a mobile communication method including a step in which a mobile station UE, upon reception of a first uplink scheduling grant (first uplink scheduling signal) containing C-RNTI (identification information of mobile station UE) of the mobile station UE from a radio base station eNB, transmits, by using an individual uplink resource designated by the first uplink scheduling grant, an uplink data signal on which a scrambling process has been performed by C-RNTI of the mobile station UE, to the radio base station eNB, and a step in which the mobile station UE, upon reception of a second uplink scheduling grant (second uplink scheduling signal) containing CB-RNTI (predetermined identification information that is not the identification information of a specific mobile station) from the radio base station eNB, transmits, by using a shared uplink resource designated by the second uplink scheduling grant, the uplink data signal on which the scrambling process has been performed by the CB-RNTI, to the radio base station eNB.

The first characteristic of the embodiment may include a step in which the radio base station eNB performs a descrambling process using C-RNTI of the mobile station UE on the uplink data signal transmitted using an individual uplink resource, and a step in which the radio base station eNB performs a descrambling process using CB-RNTI on the uplink data signal transmitted using a shared uplink resource.

The first characteristic of the embodiment may include a step in which the radio base station eNB designates CB-RNTI for the mobile station UE.

A second characteristic of the embodiment is summarized as a mobile station UE that includes a PUSCH transmission unit 13 configured, upon reception of the first uplink scheduling grant containing C-RNTI of the mobile station UE from the radio base station eNB, to transmit, by using the individual uplink resource designated by the first uplink scheduling grant, the uplink data signal on which the scrambling process has been performed by C-RNTI of the mobile station UE, to the radio base station eNB, and configured, upon reception of the second uplink scheduling grant containing CB-RNTI from the radio base station eNB, to transmit, by using the shared uplink resource designated by the second uplink scheduling grant, the uplink data signal on which the scrambling process has been performed by CB-RNTI, to the radio base station eNB.

In the second characteristic of the embodiment, the CB-RNTI may be designated by the radio base station eNB.

A third characteristic of the embodiment is summarized as a radio base station eNB that includes a PDCCH transmission unit 21 configured to transmit the first uplink scheduling grant that contains C-RNTI of the mobile station UE and designates an individual uplink resource, and to transmit the second uplink scheduling grant that contains CB-RNTI and designates a shared uplink resource, and a PUSCH reception unit 22 configured to apply a descrambling process, using C-RNTI of the mobile station UE, on the uplink data signal transmitted using individual uplink resource by the mobile station UE, and to apply descrambling process, using the CB-RNTI, on the uplink data signal transmitted using a shared uplink resource by the mobile station UE.

In the third characteristic of the embodiment, the mobile station UB may be equipped with a broadcast information transmission unit 24 or an RRC message transmission unit 25 configured to designate the CB-RNTI.

It is noted that the operation of the above-described the radio base station eNB or the mobile station UE may be implemented by a hardware, may also be implemented by a software module executed by a processor, and may further be implemented by the combination of the both.

The software module may be arranged in a storage medium of an arbitrary format such as RAM (Random Access Memory), a flash memory, ROM (Read Only Memory), EPROM (Erasable Programmable ROM), EEPROM (Electronically Erasable and Programmable ROM), a register, a hard disk, a removable disk, and CD-ROM.

The storage medium is connected to the processor so that the processor can write and read information into and from the storage medium. Such a storage medium may also be accumulated in the processor. The storage medium and processor may be arranged in ASIC. Such the ASIC may be arranged in the radio base station eNB or the mobile station UE. Further, such a storage medium or a processor may be arranged, as a discrete component, in the radio base station eNB or the mobile station UE.

Thus, the present invention has been explained in detail by using the above-described embodiments; however, it is obvious that for persons skilled in the art, the present invention is not limited to the embodiments explained herein. The present invention can be implemented as a corrected and modified mode without departing from the gist and the scope of the present invention defined by the claims. Therefore, the description of the specification is intended for explaining the example only and does not impose any limited meaning to the present invention.

1. A mobile communication method, comprising:
a step in which a mobile station, upon reception of a first uplink scheduling signal containing identification information of the mobile station from a radio base station, transmits, by using an individual uplink resource designated by the first uplink scheduling signal, an uplink data signal on which a scrambling process has been performed using the identification information of the mobile station, to the radio base station; and
a step in which the mobile station, upon reception of a second uplink scheduling signal containing predetermined identification information that is not identification information of a specific mobile station from the radio base station, transmits, by using a shared uplink resource designated by the second uplink scheduling signal, an uplink data signal on which a scrambling process has been performed using the predetermined identification information, to the radio base station.

2. The mobile communication method according to claim 1, comprising:
a step in which the radio base station performs a descrambling process, by using the identification information of the mobile station, on the uplink data signal transmitted using the individual uplink resource; and
a step in which the radio base station performs a descrambling process, by using the predetermined identification information, on the uplink data signal transmitted using the shared uplink resource.

3. The mobile communication method according to claim 1, comprising a step in which the radio base station designates the predetermined identification information for the mobile station.

4. A mobile station, comprising:
a first transmission unit configured to transmit, upon reception of a first uplink scheduling signal containing identification information of the mobile station from a radio base station, by using an individual uplink resource designated by the first uplink scheduling signal, an uplink data signal on which a scrambling process has been performed using the identification information of the mobile station, to the radio base station; and
a second transmission unit configured to transmit, upon reception of a second uplink scheduling signal containing predetermined identification information that is not identification information of a specific mobile station from the radio base station, by using a shared uplink resource designated by the second uplink scheduling signal, an uplink data signal on which a scrambling process has been performed using the predetermined identification information, to the radio base station.

5. The mobile station according to claim 4, wherein the predetermined identification information is designated by the radio base station.

6. A radio base station, comprising:
a transmission unit configured to transmit a first uplink scheduling signal that contains identification information of a mobile station and designates an individual uplink resource and to transmit a second uplink scheduling signal that contains predetermined identification information that is not identification information of a specific mobile station and designates a shared uplink resource; and
a descrambling processing unit configured to apply a descrambling process using the identification information of the mobile station, on an uplink data signal transmitted using the individual uplink resource by a mobile station and to apply a descrambling process using the predetermined identification information, on an uplink data signal transmitted using the shared uplink resource by the mobile station.

7. The radio base station according to claim 6, comprising a designation unit configured to designate the predetermined identification information for the mobile station.
